(19) United States
(12) Patent Application Publication
(10) Pub. No.: US 2014/0157099 A1
(43) Pub. Date: Jun. 5, 2014

(54) EFFICIENT SPACE ALLOCATION FOR BUSINESS OBJECTS

(71) Applicants: Rolan Abdukalykov, Montreal (CA); Mohannad El-Jayousi, L'lle-Bizard (CA); Alain Gauthier, Montreal (CA); Roy Ghorayeb, Montreal (CA); Vincent Lavoie, Montreal (CA); Xuebo Liang, Brossard (CA)

(72) Inventors: Rolan Abdukalykov, Montreal (CA); Mohannad El-Jayousi, L'lle-Bizard (CA); Alain Gauthier, Montreal (CA); Roy Ghorayeb, Montreal (CA); Vincent Lavoie, Montreal (CA); Xuebo Liang, Brossard (CA)

(21) Appl. No.: 13/693,852

(22) Filed: Dec. 4, 2012

(51) Int. Cl. G06F 17/24

(52) U.S. Cl. CPC G06F 17/245
USPC 715/227

(57) ABSTRACT

The granularity of a scale displayed on a graphical user interface may be obtained. Coordinates of rows in the graphical user interface may be determined. Visual representations of business objects to be displayed on the graphical user interface may be sorted. From the sorted visual representations, visual representations that fit into a viewable area in the graphical user interface may be identified. A start coordinate and width of each identified visual representation may be determined. A row to place each identified visual representation may be identified. Dimensions of each identified visual representation may be calculated based on dimensions of each identified visual representation's identified row.

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Traditionally, GUIs providing access to BOs conveyed limited information about the attributes associated with the BOs. In addition, the information presented by the GUIs was not drawn/rendered in an efficient manner.

### BRIEF DESCRIPTION OF THE DRAWINGS

FIG. 1 illustrates a GUI to display BOs according to an embodiment.

FIG. 2 illustrates a GUI to display BOs according to an embodiment.

FIG. 3 illustrates a GUI to display BOs according to an embodiment.

FIG. 4 illustrates a method to determine the placement of visual representations of BOs and associated detail boxes according to an embodiment.

FIG. 5 illustrates a row cache according to an embodiment.

FIG. 6 shows an exemplary architecture in an embodiment of the invention.

### DETAILED DESCRIPTION

Embodiments may be discussed in systems to efficiently display information about BOs. In an embodiment, the granularity of a scale displayed on a graphical user interface may be obtained. Coordinates of rows in the graphical user interface may be determined. Visual representations of business objects to be displayed on the graphical user interface may be sorted. From the sorted visual representations, visual representations that fit into a viewable area in the graphical user interface may be identified. A start coordinate and width of each identified visual representation may be determined. A row to place each identified visual representation may be identified. Dimensions of each identified visual representation may be calculated based on dimensions of each identified visual representation's identified row.

In an embodiment, one or more rows may be identified to place a detail box associated with an identified visual representation. Dimensions of the detail box may be calculated. In an embodiment, a cache with row information may be accessed. In an embodiment, the scale unit closest to a start attribute value of each identified visual representation's underlying business object may be determined. The scale unit may be associated with the displayed scale. A coordinate corresponding to the closest scale unit may be assigned as the start coordinate of each identified visual representation. In an embodiment, the cache may include one or more associations between a row and a visual representation of a business object and/or a detail box placed in the row.

Business software usually includes a standard set of BOs which can be utilized by the software user to model a business entity. For example, in an embodiment, business software may include BOs representing business entities such as business promotions (trade promotions), sales orders, sales quotes, customer quotes, service documents, business opportunities, etc. Each BO may include attributes which define metadata associated with the BO. For example, a business promotion BO may represent a business promotion offered by a first company through a second company to consumers. The first company may be a soft drink company and the second company may be a major retailer. The promotion may have a start date and an end date (a promotion period). The promotion may offer the product, for example, a soft drink, for the promotion period at a particular sale price. The business promotion BO may include attributes such as the name of the second company, the size of the second company, the type of the second company, the name of the promotion product, the sale price of the product during the promotion, the price of the product without the promotion, the quantity of the product sold during the promotion, the start date of the promotion, and the end date of the promotion.

Attributes of BOs may indicate a range of values. For example, in an embodiment, a business promotion BO may include one or more attributes indicating the time period for which the business promotion is valid. The time period may be implemented by either defining a single time period attribute associated with the business promotion BO or by defining a start date attribute and an end date attribute associated with the business promotion BO. Similarly, in another example embodiment, the business promotion may only apply if particular quantities of a product are purchased. Therefore, the business promotion BO may include one or more attributes indicating a range of quantities to which the business promotion applies to.

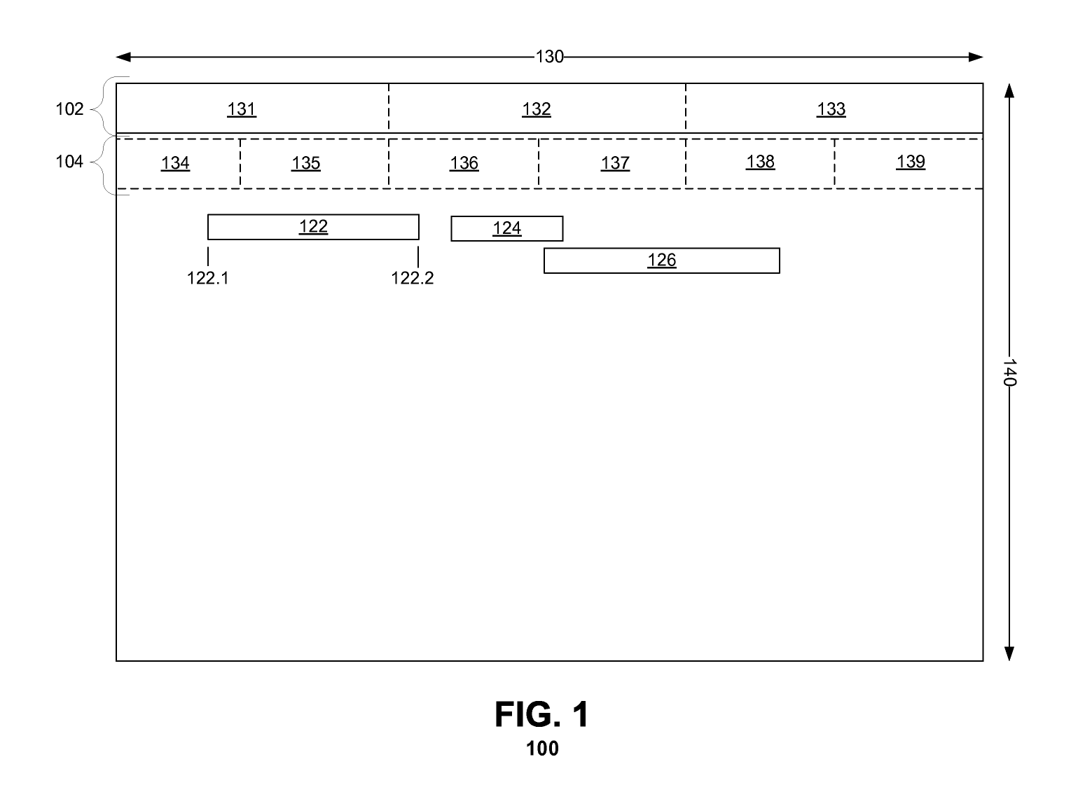

FIG. 1 illustrates a GUI 100 to display BOs according to an embodiment. In an embodiment, BOs may be displayed on a GUI 100 in an organized manner to visually convey information about the BOs. The GUI 100 may display one or more scales 102, 104 on the x-axis 130 and/or y-axis 140. The GUI 100 may display visual representations of BOs such as 122, 124, and 126 mapped in relationship to the attributes on the x-axis 130 and/or y-axis 140.

In an embodiment, the attribute(s) displayed across the x-axis 130 and/or y-axis 140 may be presented as one or more scales displaying attribute values (for example, 102 and 104). In an embodiment, if multiple scales are presented on a particular axis, each scale may be graduated based on different granularities. For example, scales 102 and 104 may represent time periods. Scale 102 may be graduated into year units. Specifically, each of 131, 132, and 133 may represent a year. Scale 104 may be graduated on a semi-annual basis. Specifically, 134-139 may each represent half of a year.

In an embodiment, there may be a correlation between the multiple scales on a particular axis. For example, there may be a correlation between the units of scale 102 and scale 104. Time period 131 on scale 102 may represent a particular year, such as year 2012. The time period 134 may represent the first half of the year 2012, and the time period 135 may represent the second half of year 2012. In an embodiment the correlated portions of multiple scales may be presented directly above/below (x-axis) or directly beside (y-axis) each other. For example, time period 131 may be located directly above/below corresponding time periods 134 and 135.

The scale(s) displayed on the x-axis and/or y-axis 102 and 104 may be a range of contiguous values and/or discrete values. For example, the scales 102 and 104 may represent a contiguous time period of three years, a contiguous price range between zero Canadian dollars and 30 Canadian dollars, a contiguous temperature range between 0 degrees Fahrenheit and 90 degrees Fahrenheit, etc. In another example, the scales 102 may represent discrete products such as car A (131), car B (132) and car C (133).

In an embodiment, one or more scales (not shown) may be presented on the y-axis 140. The y-axis scale(s) may be presented and function similar to the x-axis scale(s) described above. Although only two axes (x and y) are illustrated in FIG. 1, a person having ordinary skill in the art will appreciate that GUI 100 may be extended to display additional axes. For example, a z-axis (with corresponding scale(s)) may be displayed by utilizing shading to show the third dimension. In a further example, the z-axis (with corresponding scale(s)) may be presented by displaying GUI 100 on a display which is 3-dimension (3D) compatible.

In an embodiment, the BO(s) displayed on the GUI 100 may be positioned and presented based on respective attribute value(s) of the BO(s) relative to the x-axis and/or y-axis scale(s) of GUI 100. In an example embodiment, scale 102 may be displayed on the GUI 100 and may indicate a time period range as explained above. BOs 122, 124, and 126 may be visual representations of business promotion BOs. Each BO represented by 122, 124, and 126 may include attributes indicating the business promotion period of the respective business promotion BO. The BO visual representations 122, 124, and 126 may be presented to visually convey the span of the business promotion periods, and the start/end of the business promotion periods. For example, time periods 131, 132, and 133 may represent years 2012, 2013, and 2014 respectively. Business promotion BO 122 may have a business promotion period from Apr. 14, 2012 to Jan. 23, 2013. Thus, BO 122 may be presented as a horizontal bar extending from start point 122.1 positioned below time period 131 to end point 122.2 positioned below time period 132. The start point 122.1 may line up with a point in the time period 131 which approximately corresponds to Apr. 14, 2012, and the end point 122.2 may line up with a point in the time period 132 which approximately corresponds to Jan. 23, 2013.

In an example embodiment, multiple scales 102 and 104 may be presented on the GUI 100 and the BO visual representations 122, 124, and 126 may be presented relative to the multiple scales. For example, time periods 134, 135, and 136 may represent the first half of year 2012, the second half of year 2012, and the first half of year 2013 respectively. Business promotion BO 122 may have a business promotion period from Apr. 14, 2012 to Jan. 23, 2013 as described previously. Thus, BO 122 may be presented as a horizontal bar extending from start point 122.1 positioned below time periods 131 and 134 to end point 122.2 positioned below time periods 132 and 136. The start point 122.1 may line up with points in the time periods 131 and 134 which approximately correspond to Apr. 14, 2012, and the end point 122.2 may line up with points in the time periods 132 and 136 which approximately correspond to Jan. 23, 2013.

In an embodiment, the GUI 100 may include multiple axes and one or more scales on each of the multiple axes. Each axis (and the associated scale(s)) may represent different BO attributes. Thus, the BO(s) presented on the GUI 100 may be presented relative to the scale(s) on each axis. For example, the scale(s) on an x-axis may represent time periods and the scale(s) on a y-axis may represent price ranges. Consequently, the bars 122, 124, and 126 representing BOs such as business promotion BOs may be displayed based on the BOs' respective business promotion periods and business promotion prices. The length of the bars 122, 124, and 126 may correspond to the business promotion period, and the width of the bars 122, 124, and 126 may correspond to the business promotion price. Similarly, BOs may be displayed relative to three axes by displaying the BOs as 3D bars and varying the length, width, and depth of the bars to correspond to the scale(s) on the three axes.

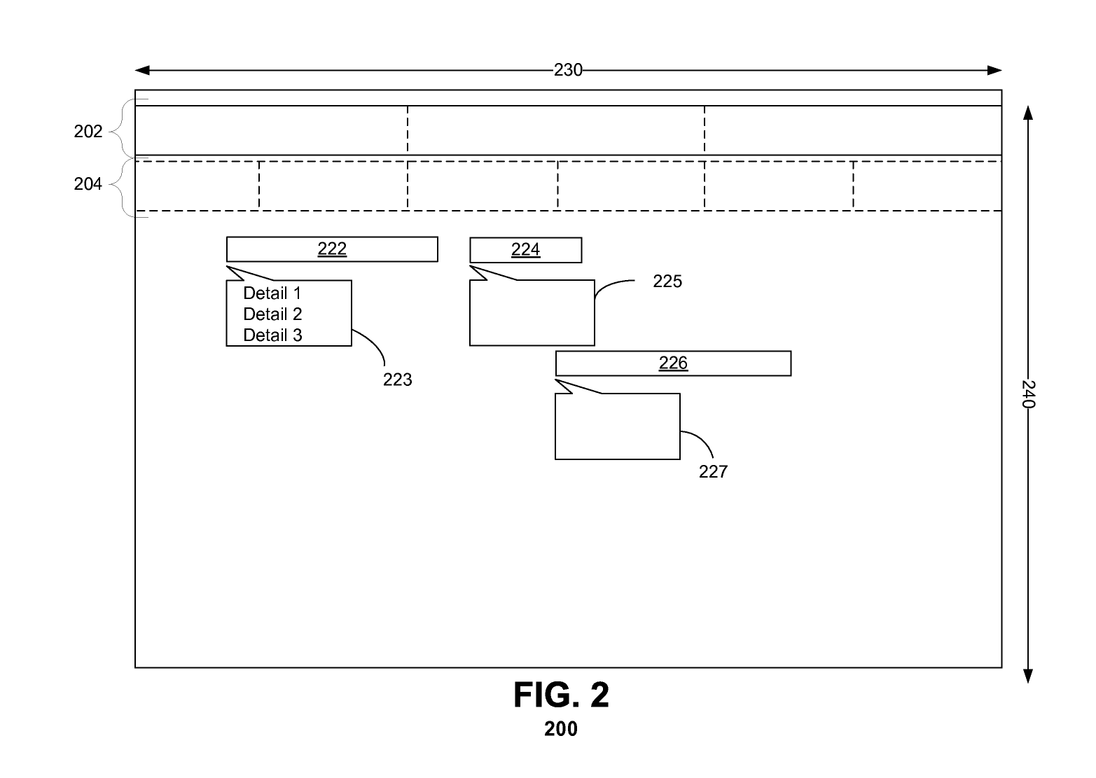

FIG. 2 illustrates a GUI 200 to display BOs according to an embodiment. In an embodiment, BOs may be displayed on a GUI 200 in an organized manner to visually convey information about the BOs. The GUI 200 may display one or more scales 202 and 204 on the x-axis 230 and/or y-axis 240. The GUI 200 may display visual representations of BOs such as 222, 224, and 226 mapped in relationship to the attributes on the x-axis 230 and/or y-axis 240 as discussed in the description pertaining to FIG. 1 above. The GUI 200 may display detail boxes 223, 225, and 227 which present details about BOs associated with BO visual representations 222, 224, and 226 respectively.

In an embodiment, the detail boxes 223, 225, and 227 may display attributes and/or other metadata associated with the respective BOs. The information presented in the detail boxes 223, 225, and 227 may be customized through GUI 200 and/or another GUI so that only the required details are displayed. In an embodiment, the size of the detail boxes 223, 225, and 227 may be customized through GUI 200 and/or another GUI to tweak the readability of the information presented in the detail boxes. In an embodiment, the user may be able to dynamically change the size of a detail box by, for example, selecting the border(s) of the detail box and dragging the border(s) of the detail box to a desired position. The user may select and drag the border(s) of the detail box by, for example, his/her finger (when utilizing a touch screen), a mouse, keyboard, trackball, etc. In an embodiment, all detail boxes 223, 225, and 227 may be displayed without the need for a user to perform any actions on BO visual representations 222, 224, and 226. Specifically, the detail boxes may be displayed without the need for the user to click on or hover a cursor over the BO visual representations 222, 224, and 226.

In a further embodiment, a toggle switch (not shown) may be presented on the GUI 200 to turn on/off the display of detail boxes. Activating the toggle switch when the detail boxes are displayed may remove all detail boxes 223, 225, and 227 from the GUI 200. In addition, the BO visual representations 222, 224, and 226 may be repositioned on the GUI 200 to better utilize the space realized from not displaying the detail boxes 223, 225, and 227. Activating the toggle switch when the detail boxes 223, 225, and 227 are not displayed may re-display the detail boxes 223, 225, and 227 again. A person having ordinary skill in the art will appreciate that the toggle switch may be implemented in many ways including a button, radio buttons, check boxes, drop down menus, etc. In an embodiment, the toggle switch may not be presented on the GUI 200, but may be implemented through output from a motion sensor within the device displaying the GUI 200. For example, shaking and/or tilting a PC tablet in a particular manner may toggle the display of detail boxes.

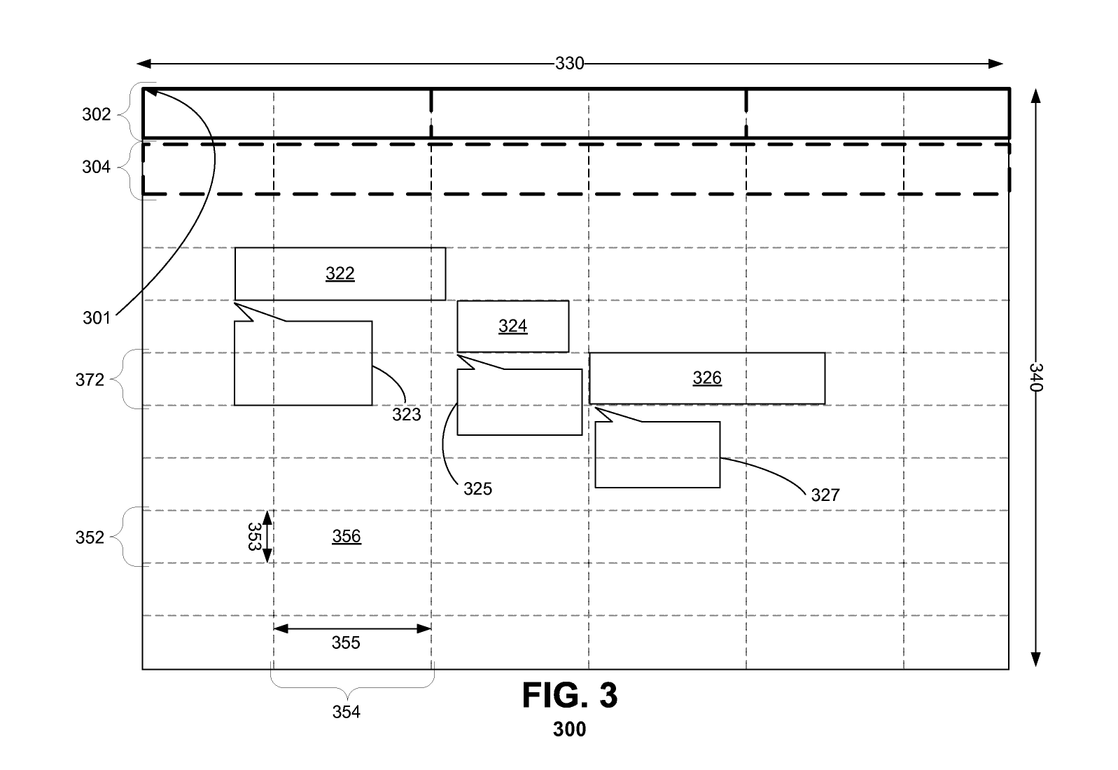

FIG. 3 illustrates a GUI 300 to display BOs according to an embodiment. In an embodiment, BOs may be displayed on GUI 300 in an organized manner to visually convey information about the BOs. The GUI 300 may display one or more scales 302 and 304 on the x-axis 330 and/or y-axis 340. The GUI 300 may display visual representations of BOs such as 322, 324, and 326 mapped in relationship to the attributes on the x-axis 330 and/or y-axis 340 as discussed in the description pertaining to FIG. 1 above. The GUI 300 may display detail boxes 323, 325, and 327 which present details about BOs associated with BO visual representations 322, 324, and 326 respectively as discussed in the description pertaining to FIG. 2 above.

In an embodiment, the information presented on GUI 300 may be drawn and/or rendered based on a coordinate system. In an embodiment, the visual information may be drawn based on a Cartesian coordinate system using absolute values (i.e., (x,y) coordinates without regard to the sign of x or y). In an embodiment, a corner, such as the top left corner 301 of the GUI 300 may represent the origin (0,0) of the coordinate system. The information presented on the GUI 300 may be drawn by using the origin 301 as a reference point.

In an embodiment, the scales 302 and 304 may be drawn relative to the reference point 301. The drawing of scales 302 and 304 may be determined by calculating the point of placement (i.e., (x,y) coordinates) of the top left corner (or origin) of the scales 302 and 304, and the dimensions (i.e., the width and height) of the scales 302 and 304. For example, the point of placement of the origin of scale 302 may be (0,0), the width may be 1920 pixels, and the height may be 50 pixels. Similarly, the point of placement of the origin of scale 304 may be (0,50) since scale 304 is right below scale 302, the width may be 1920 pixels, and the height may be 50 pixels. In an embodiment, the above information such as origin and dimensions may be provided via a programming language (dynamically or statically), and upon execution of the programming language, the scales 302 and 304 may be drawn on the GUI 300.

In an embodiment, the GUI 300 may be divided into rows such as 352 and columns such as 354. The intersection of a row and a column such as 356 may be referred to as a tile. The rows and columns may be positioned based on the coordinate system discussed above. In an embodiment, the rows and columns may not be displayed on the GUI 300, but may be used to draw information on GUI 300 such as visual representations 322, 324, and 326, and their associated detail boxes 323, 325, and 327. In an embodiment, the height 353 of all rows in GUI 300 may be equal and the width 355 of all columns in GUI 300 may be equal. The row height 353 may be dynamically determined based on the content displayed on GUI 300.

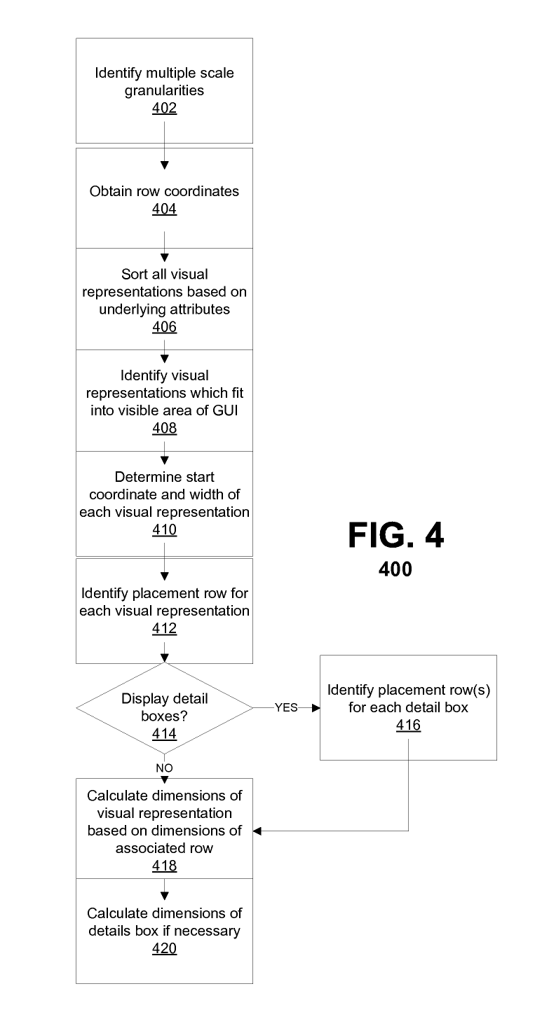

FIG. 4 illustrates a method 400 to determine the placement of visual representations of BOs and associated detail boxes according to an embodiment. The method 400 may identify the granularities of the scales displayed on a GUI 402. For example, the method 400 may determine that a scale with a yearly time granularity and a scale with a monthly granularity are displayed on the GUI. The method 400 may obtain the coordinates of the rows of the GUI 404. The method 400 may then sort the visual representations based on attributes of the underlying BOs 406. For example, the method 400 may sort visual representations of business promotion BOs based on the start date of the underlying business promotion BOs. The method 400 may identify the visual representations which fit into the visible area displayed on the GUI 408. For example, the method 400 may identify the visual representations of business promotion BOs with start and end dates within the date interval displayed by the scales presented on the GUI. For each visual representation that fits into the visible area, the method 400 may identify the visual representation's start coordinate and width 410. For each visual representation that fits into the visible area, the method 400 may determine the corresponding row in which the visual representation is to be placed 412. If detail boxes are to be displayed on the GUI 414, the method 400 may also determine the row(s) in which each visual representation's detail box is to be placed 416. The method 400 may calculate the dimensions of each visual representation based on the dimensions of the visual representation's associated row 418. For example, the method 400 may calculate the height and y-coordinate of each visual representation based on the height and y-coordinate of the associated row. If detail boxes are to be displayed on the GUI, the method 400 may calculate the dimensions of each detail box based on the associated visual representation 420. For example, the method 400 may calculate the x-coordinate, the y-coordinate, and the width of the detail box based on the start and end attributes of the associated visual representation and/or the coordinates of the associated visual representation.

In an embodiment, the method 400 may determine the start coordinate and width of each visual representation 410 by identifying the closest unit to the start attribute value of the visual representation's underlying BO. The closest unit may be associated with one or more scales displayed on the GUI. In certain instances the closest unit may be exactly equal to the value of the start attribute of the underlying BO. The method 400 may then determine the coordinate on the GUI corresponding to the closest unit and assign this coordinate as the start coordinate of the visual representation. The method 400 may calculate the number of viewable units (for example, the number of days) shown by one or more scales displayed on the GUI. Next, the method 400 may calculate the number of coordinate units per viewable scale unit. For example, the method 400 may calculate number of pixels (coordinate units) per day (viewable scale unit). In other words, the number of coordinate units per viewable scale unit=number of coordinate units in the viewable portion of the scale/number of viewable units shown by the scale. The method 400 may determine the difference between the start attribute (or the closest unit to the start attribute) and end attribute of the visual representation (i.e., the width of the visual representation in viewable scale units) and use the difference to determine the width of the visual representation in coordinate units through the equation: width in coordinate units=difference in viewable scale units*number of coordinate units per viewable scale unit.

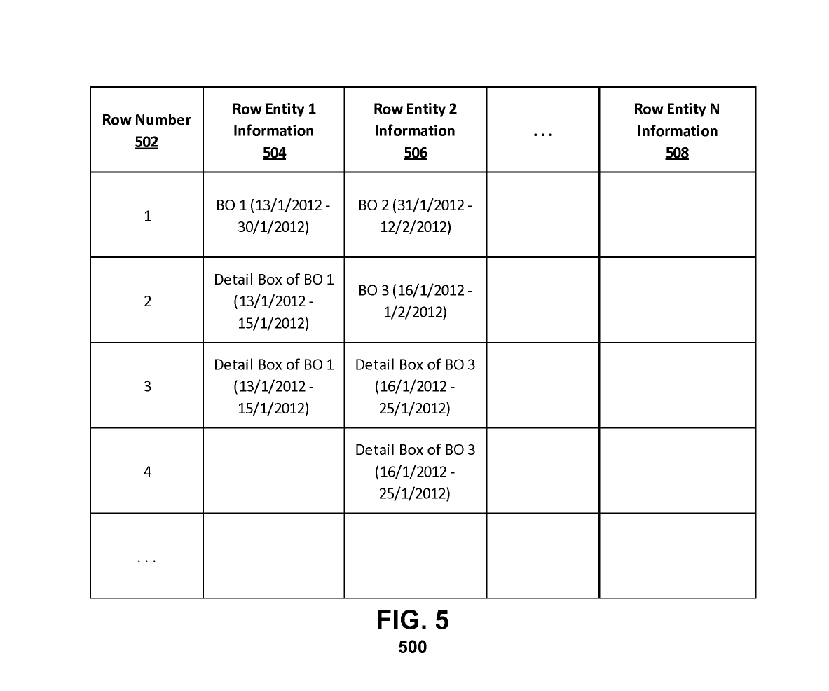

In an embodiment, the method 400 may determine the placement row for each visual representation and/or detail box utilizing information stored in a row cache. FIG. 5 illustrates such a row cache 500 according to an embodiment. The cache 500 may associate rows with row entities (i.e., visual representations and/or detail boxes) placed in the rows. The cache 500 may be keyed by a row identifier such as a row number 502. In an embodiment, the cache 500 may store information pertaining to each row entity 504-508. The information pertaining to each row entity may include the start scale unit (start attribute) and end scale unit (end attribute) of the row entity.

In an embodiment, the method 400 may determine the placement row for a current visual representation to be inserted in a row by fetching the information from a row in the cache 500. The method 400 may retrieve the last entity (i.e., row entity N 508) in the fetched row. The method 400 may compare the start scale unit (start attribute) of the current visual representation to the end scale unit (end attribute) of the retrieved last entity. If the start scale unit of the current visual representation is lower than or equal to the end scale unit of the retrieved last entity, the method 400 may iterate through the other rows in the cache 500 and repeat the above steps until the start scale unit of the current visual representation is higher than the end scale unit of the current fetched row's last entity. Once such a row is fetched, if a detail box associated with the current visual representation is to be displayed, the method 400 may calculate the start scale unit and the end scale unit of the detail box. The method 400 may compare the start scale unit of the detail box with the end scale unit of the row entities that occupy one or more rows subsequent to the current fetched row. In an embodiment, the number of subsequent rows examined may depend on the number of rows required to place the detail box since the detail box may span more than one row. If the detail box cannot be placed in the subsequent row(s), the method 400 may iterate through the rows in the cache 500 and repeat the above steps until the detail box has room for placement. Once such a row is fetched, the method 400 may then insert the current visual representation in the current fetched row and the associated detail box in the subsequent row(s).

In another embodiment, if detail boxes are not displayed on the GUI, the method 400 may retrieve the last entity (i.e., row entity N 508) in the current fetched row. The method 400 may compare the start scale unit (start attribute) of the current visual representation to the end scale unit (end attribute) of the retrieved last entity. If the start scale unit of the current visual representation is lower than or equal to the end scale unit of the retrieved last entity, the method 400 may iterate through the rows in the cache 500 and repeat the above steps until the start scale unit of the current visual representation is higher than the end scale unit of the currently fetched row's last entity. Once such a row is fetched, the method 400 may then insert the current visual representation in the current fetched row.

In an embodiment, if method 400 is unable to insert the current visual representation and/or the associated detail box in the existing rows of cache 500, the method 400 may insert the required row(s) to place the current visual representation and/or the associated detail box.

A person having ordinary skill in the art will appreciate that although the discussion above refers to the top left corner of the GUI, the BO visual representations, etc., as origins, any point within/on the border of the entities may be fixed as the origin in other embodiments. Thus, the calculations explained above may vary accordingly. The foregoing discussion refers to pixels as the unit for measuring dimensions such as the height and width of columns, rows, etc. However, any unit capable of measuring absolute/relative distance may be utilized in other embodiments. Similarly, although the above discussion illustrates drawing/rendering BO related information on a Cartesian coordinate system, the discussed principles may be applied to any other coordinate system including a Polar coordinate system, a cylindrical/spherical coordinate system, and a homogeneous coordinate system.

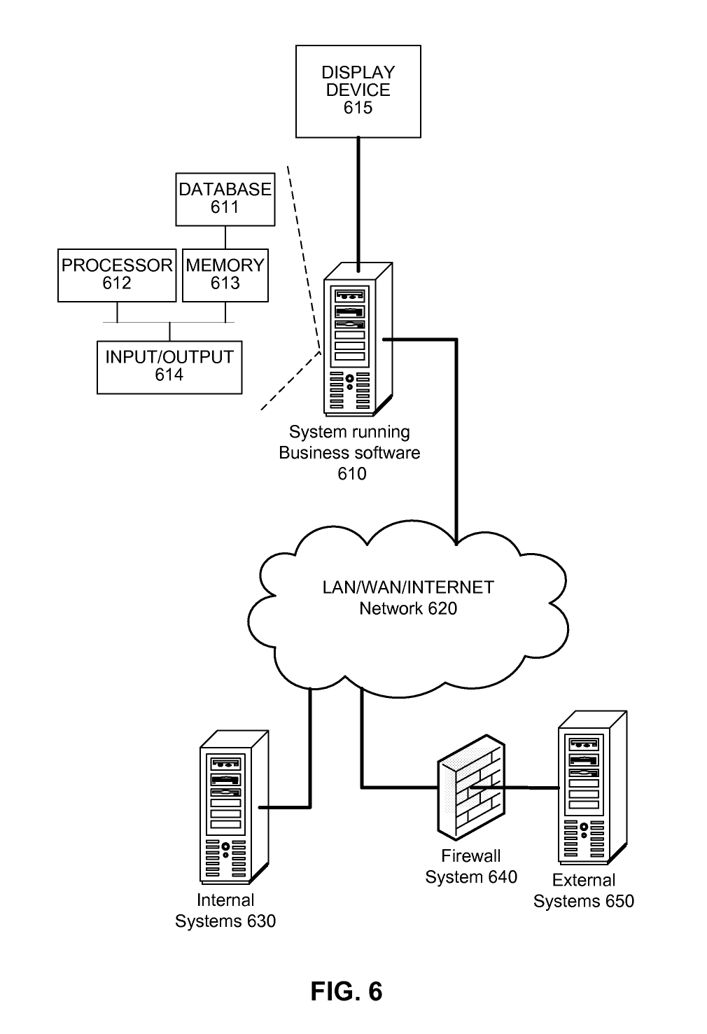

FIG. 6 shows an exemplary architecture in an embodiment of the invention. The system running an application to view, create, or modify BOs 610 may be coupled to a display device 615, existing internal systems 630 through a network 620 and to external systems 650 through the network 620 and firewall system 640. The system running an application to view, create, or modify BOs 610 may include a desktop computer, laptop computer, tablet PC, client computer, mobile phone, central computer in a vehicle, any device with a touch screen, and any other computer. The display device 615 may include a computer monitor, a touch screen, a tablet PC screen, a mobile phone screen, and any other displays. The existing internal systems 630 may include a server and may provide business data and/or other data. The external systems 650 may include a server and may be maintained by a third party, such as an information service provider, and may contain business data and/or other data, that may be updated by the third party on a periodic basis. The system running an application to view, create, or modify BOs 610 may interact with these external systems to obtain updates through a firewall system 640 separating the internal systems from the external systems.

A person having ordinary skill in the art will appreciate that while internal systems 630 and external systems 650 are included in FIG. 6, in some embodiments, one or both of these systems may not be required. In an embodiment, the functionality provided by the internal systems 630 and external systems 650 may be provided by the system running the application to view, create, or modify BOs 610.

Each of the systems in FIG. 6 may contain a processing device 612, memory 613, a database 611, and an input/output interface 614, all of which may be interconnected via a system bus. In various embodiments, each of the systems 610, 630, 640, and 650 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 613 may contain different components for retrieving, presenting, changing, and saving data. Memory 613 may include a variety of memory devices, for example, Dynamic Random Access Memory (DRAM), Static RAM (SRAM), flash memory, cache memory, and other memory devices. Additionally, for example, memory 613 and processing device(s) 612 may be distributed across several different computers that collectively comprise a system.

Database 611 may include any type of data storage adapted to searching and retrieval. The database 611 may include SAP database (SAP DB), Informix, Oracle, DB2, Sybase, and other such database systems. The database 611 may include SAP's HANA (high performance analytic appliance) in-memory computing engine and other such in-memory databases.

Processing device 612 may perform computation and control functions of a system and comprises a suitable central processing unit (CPU). Processing device 612 may comprise a single integrated circuit, such as a microprocessing device, or may comprise any suitable number of integrated circuit devices and/or circuit boards working in cooperation to accomplish the functions of a processing device. Processing device 612 may execute computer programs, such as object-oriented computer programs, within memory 613.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
obtaining a granularity of a scale displayed on a graphical user interface;
determining coordinates of rows in the graphical user interface;
sorting visual representations of business objects to be displayed on the graphical user interface;
identifying, from the sorted visual representations, visual representations that fit into a viewable area in the graphical user interface;
determining a start coordinate and width of each identified visual representation;
identifying a row to place the each identified visual representation;
calculating dimensions of the each identified visual representation based on dimensions of the each identified visual representation's identified row;
identifying at least one row to place a detail box associated with the each identified visual representation; and
calculating dimensions of the detail box.

2. A computer-implemented method comprising:
obtaining a granularity of a scale displayed on a graphical user interface;
determining coordinates of rows in the graphical user interface;
sorting visual representations of business objects to be displayed on the graphical user interface;
identifying, from the sorted visual representations, visual representations that fit into a viewable area in the graphical user interface;
determining a start coordinate and width of each identified visual representation;
identifying a row to place the each identified visual representation; and
calculating dimensions of the each identified visual representation based on dimensions of the each identified visual representation's identified row.

3. The method of claim 2, further comprising:
identifying at least one row to place a detail box associated with the each identified visual representation; and
calculating dimensions of the detail box.

4. The method of claim 3, wherein the identifying the at least one row to place the detail box includes accessing a cache with row information.

5. The method of claim 2, wherein the determining the start coordinate and the width includes:
determining a scale unit closest to a start attribute value of the each identified visual representation's underlying business object, wherein the scale unit is associated with the displayed scale; and
assigning a coordinate corresponding to the closest scale unit as the start coordinate of the each identified visual representation.

6. The method of claim 2, wherein the identifying the row to place the each identified visual representation includes accessing a cache with row information.

7. The method of claim 6, wherein the cache includes at least an association between a row and at least one of a visual representation of a business object and a detail box placed in the row.

8. An apparatus comprising:
a processor to:
obtain a granularity of a scale displayed on a graphical user interface;
determine coordinates of rows in the graphical user interface;
sort visual representations of business objects to be displayed on the graphical user interface;
identify, from the sorted visual representations, visual representations that fit into a viewable area in the graphical user interface;
determine a start coordinate and width of each identified visual representation;
identify a row to place the each identified visual representation; and
calculate dimensions of the each identified visual representation based on dimensions of the each identified visual representation's identified row.

9. The apparatus of claim 8, wherein the processor is further configured to:
identify at least one row to place a detail box associated with the each identified visual representation; and
calculate dimensions of the detail box.

10. The apparatus of claim 9, wherein to identify the at least one row to place the detail box, the processor is further configured to:
access a cache with row information.

11. The apparatus of claim 8, wherein to determine the start coordinate and the width, the processor is further configured to:
determine a scale unit closest to a start attribute value of the each identified visual representation's underlying business object, wherein the scale unit is associated with the displayed scale; and
assign a coordinate corresponding to the closest scale unit as the start coordinate of the each identified visual representation.

12. The apparatus of claim 8, wherein to identify the row to place the each identified visual representation, the processor is further configured to:
access a cache with row information.

13. The apparatus of claim 12, wherein the cache includes at least an association between a row and at least one of a visual representation of a business object and a detail box placed in the row.

14. A non-transitory computer-readable medium embodied with computer-executable instructions for causing a computer to execute instructions, the computer instructions comprising:
obtaining a granularity of a scale displayed on a graphical user interface;
determining coordinates of rows in the graphical user interface;
sorting visual representations of business objects to be displayed on the graphical user interface;
identifying, from the sorted visual representations, visual representations that fit into a viewable area in the graphical user interface;
determining a start coordinate and width of each identified visual representation;
identifying a row to place the each identified visual representation; and
calculating dimensions of the each identified visual representation based on dimensions of the each identified visual representation's identified row.

15. The computer-readable medium of claim 14, further comprising:
identifying at least one row to place a detail box associated with the each identified visual representation; and
calculating dimensions of the detail box.

16. The computer-readable medium of claim 15, wherein the identifying the at least one row to place the detail box includes accessing a cache with row information.

17. The computer-readable medium of claim 14, wherein the determining the start coordinate and the width includes:
determining a scale unit closest to a start attribute value of the each identified visual representation's underlying business object, wherein the scale unit is associated with the displayed scale; and
assigning a coordinate corresponding to the closest scale unit as the start coordinate of the each identified visual representation.

18. The computer-readable medium of claim 14, wherein the identifying the row to place the each identified visual representation includes accessing a cache with row information.

19. The computer-readable medium of claim 18, wherein the cache includes at least an association between a row and at least one of a visual representation of a business object and a detail box placed in the row.
